(19) United States
(12) Patent Application Publication
(10) Pub. No.: US 2005/0138546 A1
(43) Pub. Date: Jun. 23, 2005

(54) Personalized web page on a home network for viewing on a television

(75) Inventor: Salim S. AbiEzzi, Sammamish, WA (US)

Correspondence Address: LEYDIG, VOIT & MAYER, LTD., TWO PRUDENTIAL PLAZA, SUITE 4900, 180 NORTH STETSON, CHICAGO, IL, 60601-6780, US

(73) Assignee: Microsoft Corporation, Redmond, WA (US)

(21) Appl. No.: 10/744,720

(22) Filed: Dec. 23, 2003

(51) Int. Cl. G06F 17/21; H04N 7/173; G06F 15/16

(52) U.S. Cl. 715/513; 715/517; 715/501.1; 715/523; 715/908; 715/911; 725/112; 709/203; 709/219

(57) ABSTRACT

A home network integrates a television to enable a user to use the television to view a personalized web page composed by a media server of the home network. The media server includes components for collecting various types of information requested by the user, and composing/updating the personalized web page according to configuration information specified by the user. The television is connected to the home network via a TV client module, which presents on the television a user-selectable option of viewing the user's personalized web page. In response to the user's selecting that option, the TV client retrieves the cached personalized web page from the media server and displays it on the television for viewing by the user.

### TECHNICAL FIELD

This invention relates generally to computer networking in a home setting, and more particularly to a system and method of integrating televisions in a home with a home network for accessing information on the Internet.

### BACKGROUND OF THE INVENTION

The Internet has become an indispensable part of our daily lives. Everyday, millions of people use the Internet to read news, shop on-line, search for information, and chat with others, etc. The Internet presents a wealth of information. With thousands of websites providing downloadable information, a user can search for and gather desired information using well-developed search engines and services available on the Internet. Some websites even provide web pages customized for individual users. A user can specify to the web server providing the custom web page service the types of information she likes to see, such as weather, local traffic, world and local news, stock market reports, entertainment, sports, etc. The custom web page server will then go to various information sources to retrieve the selected types of information, and presents the collected information in the customized web page. Thus, instead of having to access multiple websites, the user only has to go to the site of the custom web page server and open her personal web page composed by the server, and all the information of the types she specified is there for her to review.

In conjunction with the expansion of the reaches of the Internet, the number of home networks has also been growing rapidly. The prices of personal computers and networking devices have fallen tremendously, and it is very easy for a household with multiple computers to set up a home network. As a result, computer networking is no longer limited to work places and has entered many homes. The availability of home networking has opened many possibilities of home automation. Such possibilities, however, are mostly unrealized at this time. Many users implement home networks mainly for the purpose of being able to access the Internet from different computers in the home and to share data and programs among the home computers, and the aspect of information/data access is largely independent of and unrelated to other aspects of home activities and functions.

For instance, watching television is a major form of home entertainment. If a user watching television in the living room wants to access the Internet to read her custom web page during a commercial break, she has to go to her study room where her personal computer is located, sit down in front of the personal computer, and use the computer to connect to the custom web page server to get her custom web page. If the Internet connection of the user is slow or if the custom web page server is slow or overloaded, the user may have to wait for a while for her custom web pages to download and is not able to see the pages instantly.

### SUMMARY OF THE INVENTION

In view of the foregoing, the present invention provides a home network system that composes and caches a personalized web page for a user and enables the user to use her television to review the personalized web page instantly. The home network includes a media server that is capable of accessing the Internet. The user can use the user interface presented by the media server to specify the types of information to be included in her personalized web page. The media server then goes to the Internet to collect information of the types specified by the user, and use the retrieved information to construct the personalized web page. The personalized web page is stored in a cache to enable instant delivery over the home network. The television is connected to a TV client on the home network. The TV client presents an option in a menu that can be selected by the user to view the personalized web page. When the user invokes the option to view her personalized web page, the TV client instantly retrieves the personalized web page cached by the media server and displays the web page on the television for viewing by the user.

### BRIEF DESCRIPTION OF THE DRAWINGS

FIG. 1 is a block diagram generally illustrating an exemplary computer system on which components of a home network configured in accordance with the invention may be implemented;

FIG. 2 is a schematic diagram showing an embodiment of a home network that constructs personalized web pages with information collected from the Internet and presents the personalized web page on a television for viewing;

FIG. 3 is a schematic diagram illustrating an exemplary user interface for a user to configure personalized web pages;

FIG. 4 is a schematic diagram illustrating exemplary user interface screens for a user to invoke the function of viewing her personalized web page on the television; and

FIG. 5 is a flow diagram summarizing the operation of constructing a personalized web page for a user and presenting the web page on a television for viewing by the user.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may be practiced in distributed computing environments where tasks are performed by remote processing devices that are linked through a communications network. In a distributed computing environment, program modules may be located in both local and remote memory storage devices.

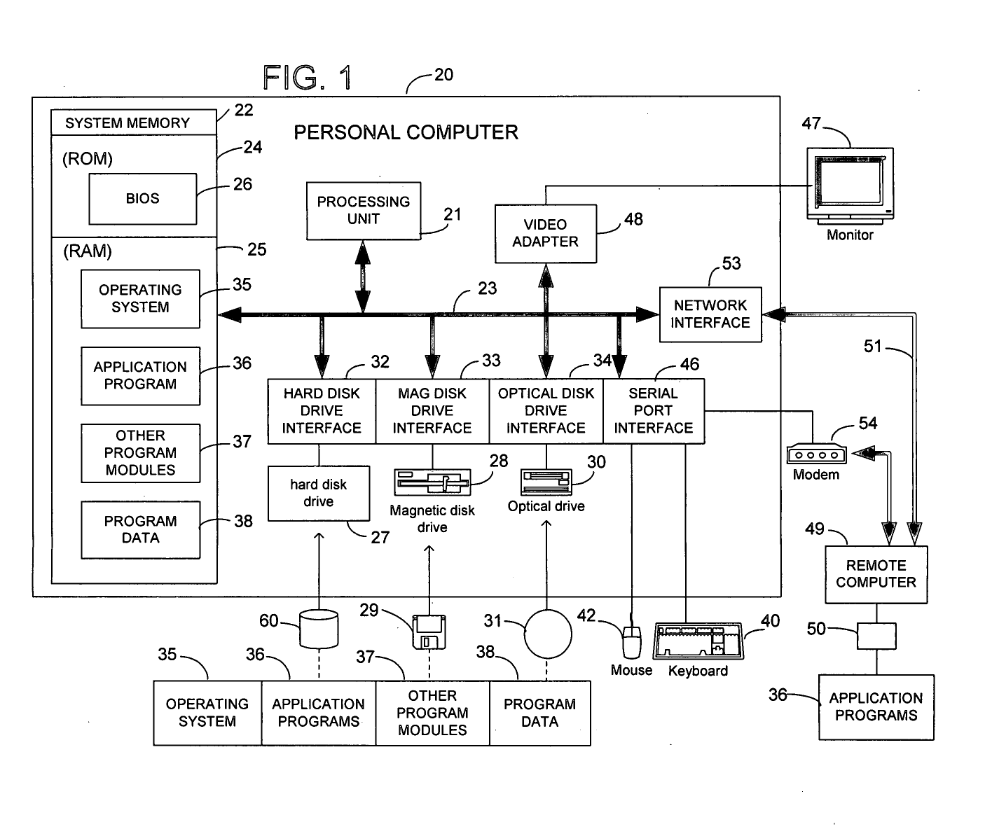

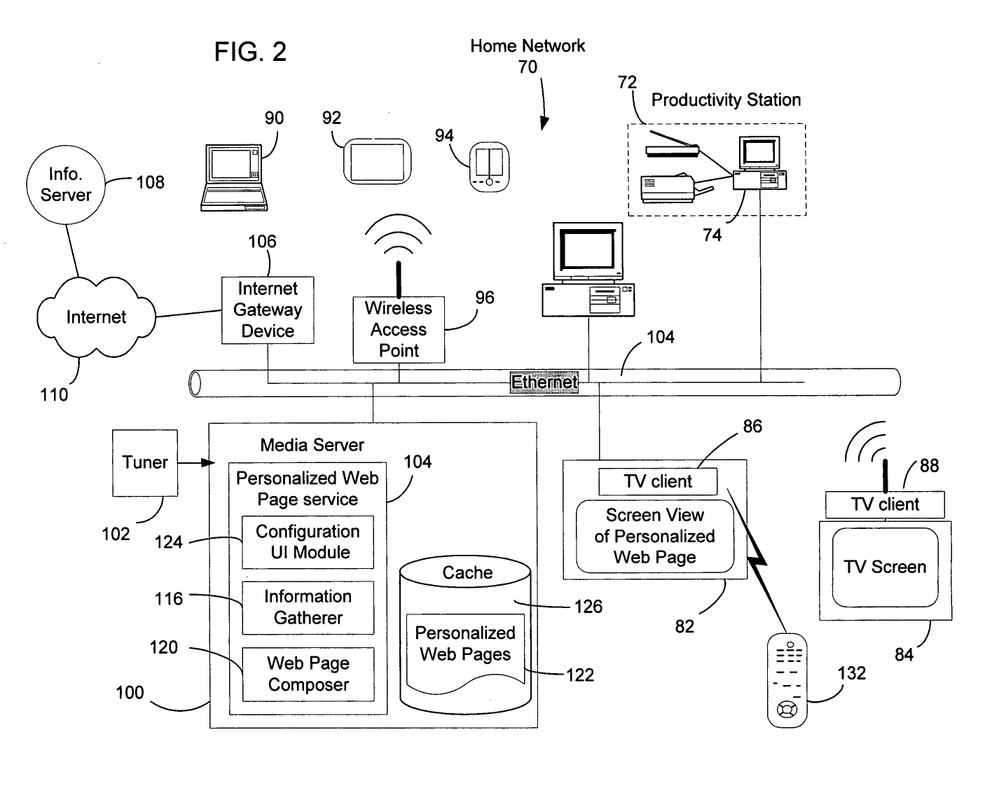

The following description begins with a description of a general-purpose computing device that may implement components of a home network of the invention for integrating data access and home entertainment. The home network architecture of the invention that compiles personalized web pages for a user and shows the pages on a television connected to the home network for viewing will be described in greater detail with reference to FIGS. 2-5. Turning now to FIG. 1, a general purpose computing device is shown in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, storage area networks, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB) or a network interface card. A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various ones of the acts and operations described hereinafter may also be implemented in hardware.

Referring now to FIG. 2, the present invention is directed to a home network 70 that is configured to provide the functionality of compiling personalized web pages for a user, and enables the user to instantly view the personalized web pages on a television. In the embodiment shown in FIG. 2, the home network 70 connects devices for work and entertainment functions. For instance, a productivity station 72, which may be located in the study room of the house, includes a desktop personal computer 74 that may be connected to the home network 70 via wired or wireless connections. The personal computer 74 may include peripheral devices, such as a printer, a scanner, and a video camera for video conferencing, etc. The home network 70 is also connected to a television 82, which may be part of a home entertainment center located in the living room of the house. As described in greater detail below, the television 82 is connected to the home network via a TV client module 86. Another television 84, which may be located in the bedroom, is also connected to the home network 70 by its TV client module 88. The home network 70 may also have wireless devices connected thereto. To that end, the home network 70 includes one (or more) wireless access point (WAP) 96 that functions as the base station for a wireless local area network (LAN) and is typically plugged into an Ethernet hub or server. The wireless communications allows a user to move around the house with her mobile device without losing connection to the home network. The wireless devices include, for example, a notebook computer 90, a tablet PC 92, a PDA 94, etc. In a preferred embodiment, the home network is based on an IP-based Ethernet local area network.

In accordance with a feature of the invention, the home network 74 further includes a media server 100. The media server 100 may be located, for instance, in an equipment room in the home. In one embodiment, the media server 100 is implemented in a personal computer. Alternatively, the media server may be a dedicated microprocessor-based device, similar to a set-top box, with adequate hardware and software implementing media service related functions. The media server 100 may be connected to various video/audio signal sources, such as a tuner 102, which may receive signals from different carries such as satellite, terrestrial, or cable (broadband) connections. The media server 100 is provided with capabilities to access the Internet 110. In the illustrated embodiment, the media server is connected to an Internet gateway device (IGD) 106, which may be connected to the Internet via a broadband cable, a DSL line, an optical connection, or a phone line (i.e., publicly switched telephone network (PSTN)). In the illustrated example, the Internet gateway device 106 is also used by the personal computer 74 in the productivity station 72 to access the Internet 110.

The media server 100 enables integration of the home entertainment components/devices with the home network 70 to provide enhanced home automation experience. In particular, in accordance with the invention, the media server 100 is capable of compiling personalized web pages in accordance with configuration information entered by the user. Moreover, the media server 100 interacts with the TV client component 86 of a television 82 to enable a user to view her personalized web page on the television. To that end, the media server 100 includes a personalized web page service software component 104 that handles the various functions related to the composition and presentation of personalized web pages. As used herein, the term “web page” is used broadly to mean a presentation that resembles HTML documents that can be downloaded from a website and viewed with an Internet browser, and does not require that the page be located at a site of the World-Wide Web on the Internet.

To allow the user to configure a personalized web page according to her preferences, the personalized web page service 104 of the media server 100 has a configuration user interface module 124 that is programmed to provide a user interface for the user to enter configuration information. The user interface may be presented on a monitor attached to the media server, and the user may use a keyboard and a pointing device attached to the media server to enter her selections. Alternatively, the user interface may be sent to any personal computer (e.g., the personal computer 74) connected to the home network 70, and the user will use the personal computer to view available options and enter her selections.

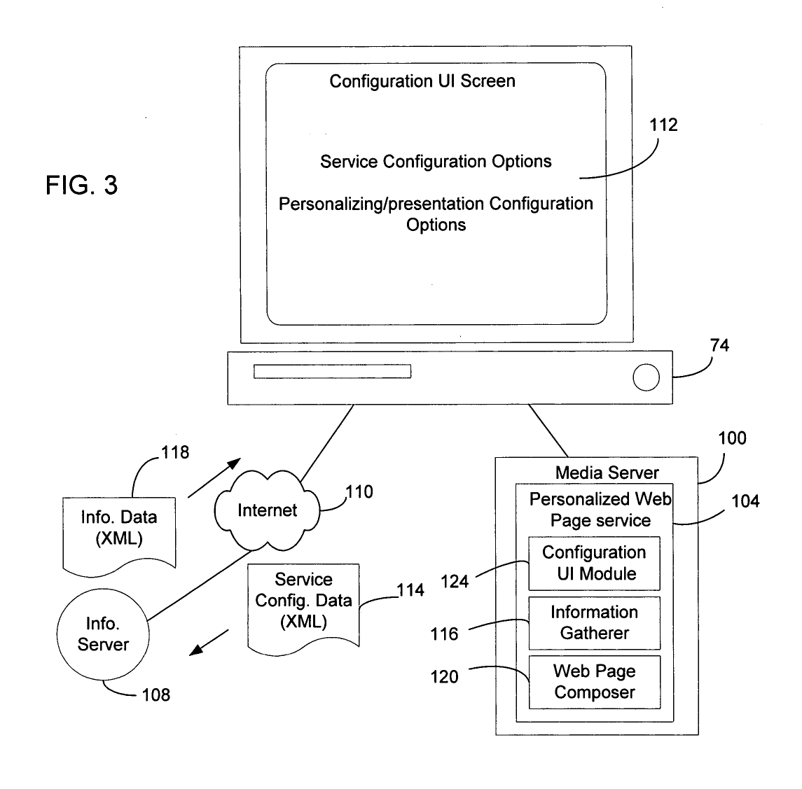

As illustrated in FIG. 3, the user interface 112 provided by the media server 100 for personalizing web pages includes queries that allow the user to enter two types of configuration information. First, to set up the service of Internet information collection, the media server 100 (or any personal computer used to present the user interface) can connect the user to an information server 108 on the Internet 1 10 that provides the service of gathering the different types of information specified by the user. The user can then enter service configuration information 114, such as billing information and terms for the service provided by the information server 108.

The user interface 112 also allows the user to enter configuration information to be used by the media server 100 to compose personalized web pages for the user. For instance, the composition configuration information may include a selection of the various types of information the user wants to include in her personalized web page. The information categories that the user can select from may include, for example, the user's e-mail inbox, the user's calendar, local traffic map, local weather report, headline stories, stock prices, selected TV guide, accurate current time, instant message buddies online, etc. The user may also specify how often the page is to be updated. The composition configuration information may also include information regarding the presentation of the personalized web page. For instance, the user may select to show her personalized web page in the form of boxes aligned along the sides of the television screen while showing the regular TV program in the center portion of the screen, or to use the entire television to show the personalized web page. The user may also select to format the page to fit on the entire television. For instance, if the television has an aspect ratio of 16:9, which is longer and narrower than the 4:3 aspect ratio of conventional televisions and computer display screens, the user can select to configure the personalized web page to fit on the entire screen instead of leaving empty bars on the sides.

Once the user has entered appropriate configuration information for her personalized web page, the media server 100 constructs the personalized web page. To that end, the media server 100 includes an information gatherer component 116 that periodically goes to the information server 108 or other information sources on the Internet 110 to download up-to-date information in information categories selected by the user for her personalized web page. Alternatively or in conjunction with the periodic downloading, the information server 108 may also provide information in a “push” mode to the media server 100 whenever there are changes to any information category selected by the user. In a preferred embodiment, the information sent by the information server 108 to the media server 100 for populating the personalized web page may be in the format of an XML document 118.

With the information obtained from the information server 108 or other Internet sources, a web page composer component 120 of the media server constructs or edits the personalized web page to contain the up-to-date information, and saves the composed/updated personalized web page 122 in a cache 126 that allow fast retrieve of the page upon demand. To enable instant display of the personalized web page on the television on demand, the web page composer 120 preprocesses the page for fast transfer to the TV client 86 and easy rendering by the TV client for display on the television 82. The preprocessed page may be in one of several suitable formats, such as a JPEG image, a RDP stream, or an HTML file. By way of example, the web page composer 120 may preprocess the personal web page (e.g., described in HTML) to an image stored in the memory, and then compresses this image into a JPEG file, which is transmitted on demand to the TV client, which in turn renders the JPEG for display on the television. The RDP and HTML forms of representation entail greater complexity but also provide more flexibility.

When the TV client 86 of a television 82 is connected to the home network 70, it automatically discovers the personalized web page service 104 on the media server 100. The discovery may be performed, for example, using the Universal Plug-and-Play (UPnP) process. The TV client 86 then forms a communication link with the media server over the home network.

Returning to FIG. 2, to enable the user to invoke the function of viewing her personalized web page, the TV client 86 is programmed to provide a user interface on the television 82 to allow the user to select that function. When the TV client 86 discovers the personalized web page service, it populates a local menu with a “View Personal Web Page” option that can be selected by the user by, for example, pressing buttons on a remote control 132. On any television in the house that has a TV client device connected to the home network 70, a user can use a remote control 132 to send command signals to the TV client to interactively select options presented by the TV client on the television.

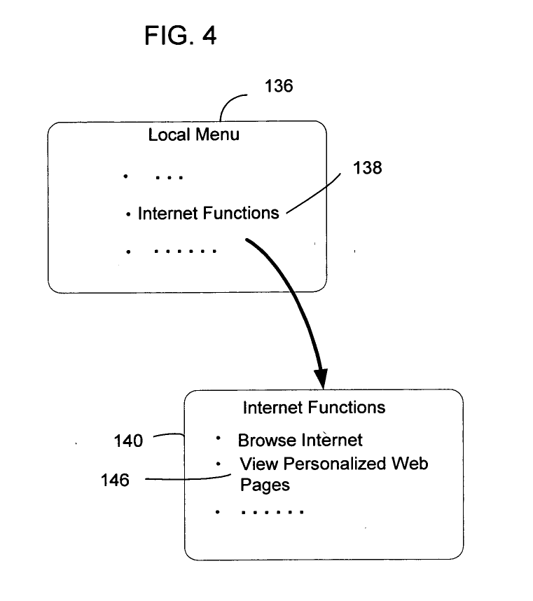

Turning now to FIG. 4, in one exemplary implementation, the local menu of the media client 86 has a starting page 136 that presents a menu option 138 of “Internet Functions.” When the user viewing the television 82 uses the remote control to select that option, the TV client receives the command and displays the next menu page 140 that includes the option 146 of “View Personalized Web page.” When the user selects the “View Personalized Web page” option, the TV client 86 transmits a request to the media server 100 to invoke that function. In response, the media server 100 retrieves the personalized web page 122 from the cache 126 and transmits it to the TV client 86. The TV client 86 then displays the received personalized web page on the television 82 for viewing by the user. Since the personalized web page can be retrieved quickly from the local cache 126 and transmitted over the home network to the TV client at a high speed, it can be displayed on demand instantly on the television 82.

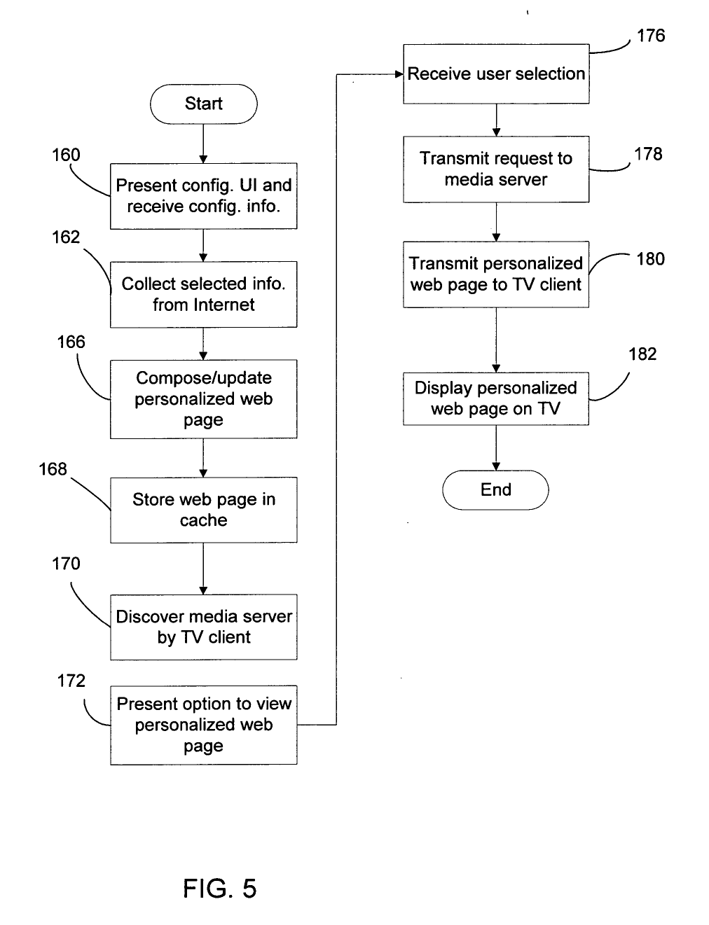

The operations of the media server 100 and the TV client 86 in the embodiment of FIG. 2 for enabling the instant viewing of a personalized web page on a television is summarized in FIG. 5. To set up a personalized web page, the user enters configuration information through the user interface presented by the media server. (step 160). The configuration user interface may be, for example, displayed on the personal computer 74 functioning as a remote terminal. The configuration information includes, for example, the billing information to be used by the information server on the Internet, the types of information to be included in the personalized web page, the presentation of the page, etc. The information gatherer 116 of the media server then collects the desired information from the Internet (step 162), which may include periodically downloading the information from an information server 108 on the Internet 110, or receiving information pushed down by the information server. The web page composer 120 of the personalized web page service 104 then constructs or updates the personalized web page 122 according to the configuration information provided by the user (step 166), and saves the web page in a cache 126 to allow fast retrieval (step 168). Upon connecting the TV client 86, the TV client discovers the media server 100 on the home network and its personalized web page service 104 (step 170). The TV client 86 then includes an option of “View Personalized Web Page” in a local menu as part of its user interface (step 172). When the user selects that option (step 176), the TV client 86 sends the request to the media server 100 (step 178). In response, the media server 100 retrieves the personalized web page 122 from its cache 126, and transmits the page over the home network to the TV client 86 (step 180). The TV client 86 then displays the personalized web page on the television 82 for viewing by the user (step 182).

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1. A computer-readable medium having computer executable instructions for a media server on a home network to perform steps of:
presenting a user interface for a user to enter configuration information for a personalized web page, the configuration information including specified types of information to be included in the personalized web page;
retrieving information of the specified types from the Internet;
constructing the personalized web page using the information retrieved from the Internet;
receiving a request from a television client on the home network for viewing the personalized web page, the television client being connected to a television;
transmitting the personalized web page over the home network to the television client for display on the television for viewing.

2. A computer-readable medium as in claim 1, wherein the step of retrieving retrieves information from an information server on the Internet.

3. A computer-readable medium as in claim 1, wherein the step of retrieving retrieves information from the Internet at pre-selected intervals.

4. A computer-readable medium as in claim 1, wherein the step of presenting includes transmitting user interface screens to a computer connected to the home network for display by said computer.

5. A computer-readable medium as in claim 1, wherein the configuration information includes information regarding presentation of the personalized web page.

6. A computer-readable medium as in claim 1, wherein the step of presenting includes transmitting configuration information entered by a user to an information server on the Internet.

7. A computer-readable medium as in claim 1, having further computer-executable instructions for performing the step of storing the constructed personalized web page in a cache.

8. A media server on a home network, comprising:
a personalized web page service having a configuration user interface component for presenting a user interface for a user to enter configuration information for a personalized web page, an information gathering component for obtaining from the Internet specified types of information identified by the configuration information for inclusion in the personalized web page, and a web page composer component for constructing a personalized web page using the information obtained from the Internet according to the configuration information, the personalized web page service being further programmed for receiving a request from a television client on the home network for viewing the personalized web page, and in response to said request transmitting the personalized web page over the home network to the television client for display on a television connected to the television client; and
a cache for storing the personalized web page.

9. A media server as in claim 8, wherein the media server is implemented on a computer connected to the home network.

10. A media server as in claim 8, wherein the information gatherer component is programmed to retrieve information from an information server on the Internet.

11. A media server as in claim 10, wherein the configuration user interface component is programmed to transmit configuration information entered by a user to the information server on the Internet.

12. A media server as in claim 8, wherein the configuration information includes information regarding presentation of the personalized web page.

13. A media server as in claim 8, wherein the configuration user interface component is programmed to transmit user interface screens to a computer connected to the home network for display by said computer.

14. A computer-readable medium having computer-executable instructions for a television client connected to a home network to perform steps of:
discovering a personalized web page service of a media server on the home network;
presenting on a television connected to the television client a user interface having a user-selectable option to view a personalized web page;
receiving an input signal selecting the option to view the personalized web page;
sending a request to the personalized web page service to retrieve the personalized web page;
receiving the personalized web page over the home network from the personalized web page service; and
displaying the personalized web page on the television.

15. A home network comprising:
a local area network;
a media server connected to the local area network, the media server having a personalized web page service that has a configuration user interface component for presenting a user interface for a user to enter configuration information for a personalized web page, an information gathering component for obtaining from the Internet specified types of information identified by the configuration information for inclusion in the personalized web page, and a web page composer component for constructing a personalized web page using the information obtained from the Internet according to the configuration information, the media server further including a cache for storing the personalized web page;
a television; and
a television client connected to the local area network and connected to the television for transmitting images for display on the television, the television client being programmed to present on the television a user selectable option to view the personalized web page, send a request to the media server to retrieve the personalized web page upon receiving an input signal selecting the option to view the personalized web page, receive the personalized web page from the media server, and display the personalized web page on the television for viewing,
the personalized web page service being programmed to transmit the personalized web page over the local area network to the television client in response to the request by the television client.

16. A home network as in claim 15, wherein the media server is implemented on a personal computer connected to the local area network.

17. A home network as in claim 15, wherein the information gatherer component of the media server is programmed to retrieve information from an information server on the Internet.

18. A home network as in claim 17, wherein the configuration user interface component is programmed to transmit configuration information entered by a user to the information server on the Internet.

19. A home network as in claim 18, wherein the configuration information includes information regarding presentation of the personalized web page.

20. A home network as in claim 15, further including a computer connected to the local area network, wherein the configuration user interface component is programmed to transmit user interface screens to the personal computer for display by said computer.

21. A home network as in claim 15, wherein the local area network includes a wireless access point.

22. A home network as in claim 21, wherein the television client communicates wirelessly with the wireless access point.
